(19) United States
(12) Patent Application Publication
(10) Pub. No.: US 2017/0289583 A1
(43) Pub. Date: Oct. 5, 2017

(54) METHOD AND SYSTEM FOR OPTIMIZING PUBLICATION OF LIVE BROADCASTING MESSAGE

(71) Applicants: LE HOLDINGS (BEIJING) CO., LTD., Beijing (CN); LECLOUD COMPUTING CO., LTD, Beijing (CN)

(72) Inventor: Bin LIU, Beijing (CN)

(21) Appl. No.: 15/246,250

(22) Filed: Aug. 24, 2016

Related U.S. Application Data
(63) Continuation of application No. PCT/CN2016/088909, filed on Jul. 6, 2016.

(30) Foreign Application Priority Data
Mar. 30, 2016 (CN) 201610191728.6

(51) Int. Cl. H04N 21/234; H04N 21/254; H04L 29/06; H04N 21/2187

(52) U.S. Cl. CPC H04N 21/234; H04N 21/2187; H04N 21/23406; H04N 21/2541; H04L 69/16; H04L 12/4633

(57) ABSTRACT

A method and a system are provided for optimizing publication of live broadcasting message. The method includes: configuring a message transferring station between a messager pool for publishing a live broadcasting message and a stream creating component; creating by the stream creating component the live broadcasting message and sending by the stream creating component the live broadcasting message to the message transferring station; and sending by the message transferring station the received live broadcasting message to the messager pool.

### CROSS REFERENCE TO RELATED APPLICATIONS

This application is a continuation of International Application No. PCT/CN2016/088909, filed on Jul. 6, 2016, which is based upon and claims priority to Chinese Patent Application No. 201610191728.6, filed on Mar. 30, 2016, the entire contents of which are incorporated herein by reference.

### TECHNICAL FIELD

Embodiments of the present disclosure relate to the technical field of video live broadcasting, and more particularly to a method and system for optimizing publication of live broadcasting message.

### BACKGROUND

With the rapid development of internet technologies, the streaming media technology has been widely applied to live broadcasting platforms of services such as real-time news, online video live broadcasting, online video recording and broadcasting, distance learning, real-time video conferences and the like. As an existing online live broadcasting platform generates data based on a stream as a basic unit; that is, the creation of a stream corresponds to a process or a thread, when the number of live broadcasting streams is increasing, in a traditional message publishing manner, each process or thread needs to establish a TCP long connection communication with a native messager pool (which is a device module for publishing and receiving messages and capable of receiving subscribing and publishing requests).

However, during implementation of the present disclosure, the inventor finds that the prior art at least has the following problems: after the number of streams reaches tens of thousands, the service capacity of a separate server is limited, which is caused by not only a limited number of native ports of an operating system but also the gradually increased consumption of operating system resources for establishing a large number of TCP sockets. In addition, a capacity of the messager pool for publishing messages is further weakened as challenges to the messager pool will be more and more serious along with the gradual increase of the number of native stream creating processes and threads.

### SUMMARY

In a first aspect, the present disclosure provides a method for optimizing publication of live broadcasting message, including: configuring a message transferring station between a messager pool for publishing a live broadcasting message and a stream creating component; creating by the stream creating component the live broadcasting message and sending by the stream creating component the live broadcasting message to the message transferring station; and sending by the message transferring station the received live broadcasting message to the messager pool.

In a first aspect, the present disclosure provides a system for optimizing publication of live broadcasting message including a messager pool for publishing a live broadcasting message and a stream creating component, wherein a message transferring station is configured between the messager pool and the stream creating component, the stream creating component is configured to create the live broadcasting message and send the live broadcasting message to the message transferring station, and the message transferring station is configured to receive the live broadcasting message and send the live broadcasting message to the messager pool.

In a third aspect, the present disclosure provides a non-transitory computer-readable medium. The non-transitory computer-readable medium may include executable instructions, where the executable instructions, when executed by an electronic device including a processor, cause the electronic device to: publish a live broadcasting message; configure a message transferring station between a messager pool and a stream creating component; create a live broadcasting message and send the live broadcasting message to the message transferring station; and receive the live broadcasting message and send the live broadcasting message to the messager pool.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a framework structural drawing of a live broadcasting message publishing system in the prior art;

FIG. 2 shows a schematic structural drawing of a system for optimizing publication of live broadcasting message according to an embodiment of the present disclosure; and

FIG. 3 shows a flow chart of a method for optimizing publication of live broadcasting message according to an embodiment of the present disclosure.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise.

It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

The embodiments of the present disclosure provides a method for optimizing publication of live broadcasting message and system to solve problems that in a conventional live broadcasting platform, each stream process or thread needs to establish a Transmission Control Protocol (TCP) long connection with a messager pool, but when stream processes or threads are increasing, the consumption of system resources is increased, which will limit the service capacity of a separate server and affect a capacity of the messager pool for publishing messages. Therefore, effects of greatly improving the load capacity of an online device and the capacity of the messager pool for publishing the messages are realized. The embodiments of the present disclosure will be illustrated in detail with reference to the drawings hereafter.

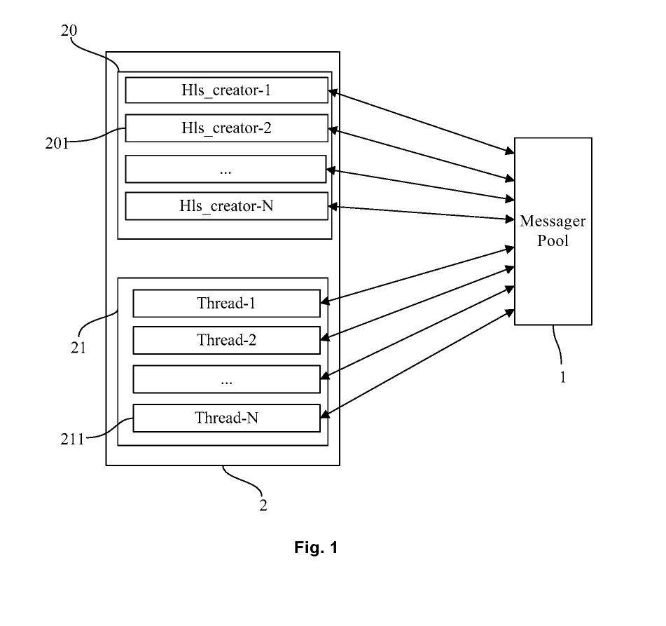

FIG. 1 schematically shows a framework structural drawing of a live broadcasting message publishing system in the prior art. Since the creating of a stream corresponds to a process or a thread, as shown in FIG. 1, generally, a stream creating component 2 includes process groups 20 and thread grounds 21 for creating streams. Each progress group 20 includes a plurality of processes 201 for creating streams (for example, Hls_creator processes shown in FIG. 1, and each process is a creating process for converting live broadcasting streams of various protocols into a specific internal hls protocol, and may create an m3u8 file with a ts). Each thread group 21 includes a plurality of threads 211 for creating streams (for example, each of the Threads shown in FIG. 1 is a rolling broadcasting creating thread for analog-converting various live broadcasting streams and on-demand broadcasting files to a live broadcasting hls protocol and may create an m3u8 file). It should be noted that an hls (http live streaming) protocol is a streaming media protocol, implemented based on an HTTP protocol, and applied to transmission of two parts, namely an m3u8 description file and a ts media file.

According to a traditional live broadcasting message publishing way, as shown in FIG. 1, each process 201 or thread 211 needs to establish a TCP long connection (which is represented by a bidirectional arrow in FIG. 1) with a native messager pool 1 (the message pool), and sends a created live broadcasting message to the messager pool 1 via the corresponding TCP long connection, and then the messager pool 1 publishes the live broadcasting message. Therefore, if the number of native live broadcasting streams is increasing, especially when the number reaches tens of thousands, the service capacity of a separate server is further limited, which is caused by not only a limited number of native ports of an operating system but also the gradually increased consumption of operating system resources for establishing a large number of TCP sockets. In addition, a capacity of the messager pool for publishing messages is further weakened as challenges to the messager pool will be more and more serious.

Thus, the present disclosure provides a system for optimizing publication of live broadcasting message and method to solve the defects in the traditional publishing structure and way.

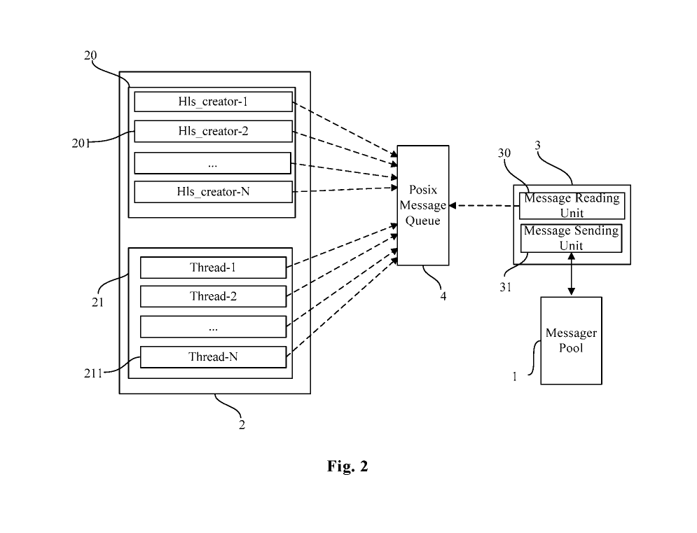

FIG. 2 schematically shows a schematic structural drawing of a system for optimizing publication of live broadcasting message according to an embodiment of the present disclosure. As shown in FIG. 2, a message transferring station 3 is further configured between a messager pool 1 for publishing a live broadcasting message and a stream creating component 2. In the system provided by the present embodiment, after creating live broadcasting messages, process groups 20 and thread groups 21 in the component 2 will send the live broadcasting messages to the message transferring station 3, and the message transferring station 3 sends the live broadcasting messages to the messager pool 1 to be published. Therefore, none of the processes 201 and threads 211 needs to directly establish a TCP connection with the messager pool 1, so long as it sends the live broadcasting message to the message transferring station 3. During live broadcasting, as the all stream creating processes and threads are in synchronous blocking and the message transferring station 3 is in asynchronous non-blocking, the live broadcasting messages can be sent to the messager pool 1 orderly to enable the messager pool 1 to publish the live broadcasting messages only by establishing a fixed number of TCP connections between the message transferring station 3 and the messager pool 1. Thus, the docking difficulty between the stream creating component 2 and the messager pool 1 can be reduced, and a capacity of the messager pool 1 for publishing messages is improved.

In a particular implementation as shown in FIG. 2, the stream creating component 2 sends a live broadcasting message to the message transferring station 3 via a PosixMQ (Portable Operating System Interface Message Queue, hereinafter referred to as a Posix message queue). The stream creating component 2 includes a message writing unit (not shown in FIG. 2) configured to write a created live broadcasting message to a local Posix message queue. The message transferring station 3 includes a message reading unit 30 configured to read the live broadcasting message from the Posix message queue and insert the live broadcasting message to a message transferring queue. As the stream creating component 2 is composed of processes or threads, the message writing unit in the present embodiment may be a stream creating process or thread. The message reading unit 30 may be a separate thread in the message transferring station. All processes and threads may read and write (dotted arrows shown in FIG. 2 represent reading and writing operations on the Posix message queue via the processes or threads) the local Posix message queue, without establishing a TCP connection for transmission, so that the system overhead can be very small, and the load capacity of an online device is significantly improved.

As shown in FIG. 2, the message transferring station 3 further includes a message sending unit 31 configured to establish a fixed number of TCP connections between the message transferring station 3 and the messager pool 1, and send all live broadcasting messages in a message transferring queue to the messager pool in real time or at a fixed time interval via the TCP connections. After the message transferring station 3 inserts the live broadcasting messages into its own message transferring queue, the message sending unit 31 will establish a fixed number of TCP connections between the message transferring station 3 and the messager pool 1 to send all live broadcasting messages in the message transferring queue to the messager pool 1 in real time, and the messager pool 1 publishes the messages. In order to ensure the real-time nature, under normal circumstances, the message sending unit 31 continues sending the live broadcasting messages in the message transferring queue, while for ensuring the system performance, the sending manner may be set such that when it is detected that the message transferring queue is empty, the message transferring queue is re-detected after a fixed time interval, such as 200 milliseconds, to confirm whether there are live broadcasting messages therein; if yes, all the live broadcasting messages are sent out; or if no, the message transferring queue will be re-detected after another fixed time interval, such as 200 milliseconds.

The number of TCP connections, between the message transferring station and the messager pool, established by the message sending unit 31 can be set as required. If there are lots of data, five TCP connections are established, or if the data are less, only one TCP connection is established, so that the system overhead is reduced. Preferably, the number of TCP connection established is one, here, the system overhead of an online device is minimized; that is, the system overhead accounts for 1/N of the original cost, wherein N indicates the total number of processes and threads in the stream creating component 2.

In order to more clearly mark each live broadcasting message and conveniently and quickly send liver broadcasting messages to a user orderly, for example, when all processes or threads of the stream creating component 2 write the live broadcasting messages into a Posix message queue, a format of a written live broadcasting message can be set to json. That is, a message writing unit first encapsulates the live broadcasting message to be in a json format, and a generating time, a serial number and a type (may be live broadcasting or rolling broadcasting) and a topic publishing location (which is a topic, where the live broadcasting message is sent, in the messager pool, such as relay/hls/lunbo/lb_zonghe_1300) of an m3u8 file corresponding to the live broadcasting message are encapsulated into the json format. Thus, the message writing unit can write the encapsulated live broadcasting messages orderly into the Posix message queue according to the serial numbers. After reading data of the json format from the Posix message queue, a message reading unit can insert the live broadcasting messages into the message transferring queue, thereby ensuring the ordering of the live broadcasting messages, avoiding confusion or hop broadcasting, and guaranteeing that the live broadcasting messages can be quickly and accurately published to a destination.

In the system for optimizing publication of live broadcasting message provided by the present embodiment, the messager pool, the stream creating component and the message transferring station may be a server or server cluster, wherein each unit may be a separate server or server cluster. Thus, interaction among the above units is that among the servers or the server clusters corresponding to the all units, and the plurality of servers or server clusters constitute the system for optimizing publication of live broadcasting message provided by the present disclosure.

Specifically, the system for optimizing publication of live broadcasting message formed by the plurality of servers or server clusters includes:

a message writing server or server cluster configured to write a created live broadcasting message into a message queue of a stream creating component;

a message reading server or server cluster configured to read the live broadcasting message from the message queue of the stream creating component, and insert the live broadcasting message into a message transferring queue of a message transferring station; and

a message sending server or server cluster configured to establish a fixed number of TCP connections between the message transferring station and the messager pool, send the live broadcasting message to the messager pool in real time via the TCP connections, or re-detect the message transferring queue at a fixed time interval when it is detected that the message transferring queue of the message transferring station is empty, and send all live broadcasting messages in the message transferring queue to the messager pool via the TCP connections when the message transferring queue is not empty.

In an alternative embodiment, several units in the above multiple units together form a server or server cluster. For example, the message writing unit constitutes a first server or a first server cluster, and the message reading unit and the message sending unit constitute a second server or a second server cluster.

In this connection, interactions among the above units are represented as interactions between the first and the second servers or the first and the second server clusters, and the first and the second servers or the first and the second server clusters together constitute the system for the system for optimizing publication of live broadcasting message of the present disclosure.

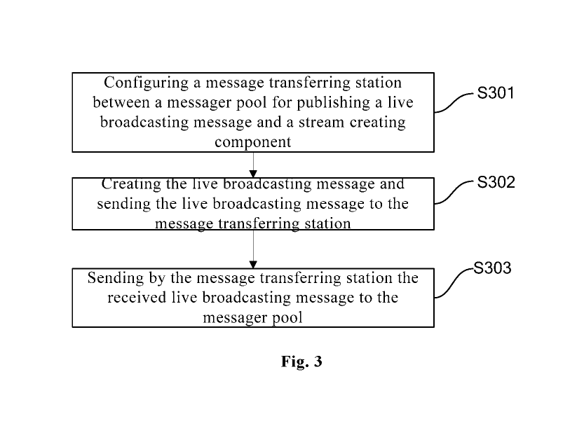

FIG. 3 schematically shows a flow chart of a method for optimizing publication of live broadcasting message according to an embodiment of the present disclosure. As shown in FIG. 3, the method includes the follows steps.

In step S301, a message transferring station is configured between a messager pool for publishing a live broadcasting message and a stream creating component.

The stream creating component is configured to create the live broadcasting message, and mainly includes a process group and a thread group. The messager pool is configured to publish the created live broadcasting message, and is a message publishing module. A module (namely, the message transferring station) is additionally arranged between the stream creating component and the messager pool, and is configured to receive the created live broadcasting message and send the live broadcasting message to the messager pool.

In step S302, a live broadcasting message is created, and the created live broadcasting message is sent to the message transferring station.

Each of the processes and threads in the stream creating component creates the live broadcasting message and sends the live broadcasting message to the message transferring station. During live broadcasting or rolling broadcasting, since each of the processes and threads creates the live broadcasting message in a synchronous blocking manner, and the message transferring station, as a transferring module, is asynchronous non-blocking, the created live broadcasting message can be sent to the message transferring station by writing it in a Posix message queue. Specifically, the implementation process includes the steps that each of the processes and threads in the stream creating component creates the live broadcasting message, and the created live broadcasting message is written in the Posix message queue, wherein a writing process may be performed according to certain rules. A separate thread is set in the message transferring station and responsible for reading the live broadcasting message from the Posix message queue. The message transferring station includes a message transferring queue configured to store the live broadcasting message read from the Posix message queue.

The certain rules for live broadcasting message writing is embodied as that for example, a transmission format of the written live broadcasting message can be set to json. That is, first, the live broadcasting message is encapsulated as data of the json format, and a generating time, a serial number and a type (may be live broadcasting or rolling broadcasting) and a topic publishing location (which is a topic, where the live broadcasting message is sent, in the messager pool, such as relay/hls/lunbo/lb_zonghe_1300) of an m3u8 file corresponding to the live broadcasting message are encapsulated into the json format. Thus, live broadcasting messages can be orderly written in the Posix message queue according to the serial numbers and inserted into a message transferring queue, without confusion, and can be quickly and accurately published to a destination.

In step S303, the message transferring station sends the received live broadcasting message to the messager pool.

A fixed number (such as one or more) of TCP connections is established between the message transferring station and the messager pool. The message transferring station sends live broadcasting messages to the message pool via the established TCP connection. Then the message pool publishes the received live broadcasting messages. Under normal circumstances, the message transferring station sends data in a message transferring queue to the messager pool in real time. In another embodiment of the present disclosure, the sending manner can be set that when it is detected that the message transferring queue is empty, the message transferring queue is re-detected after a fixed time interval (such as 200 milliseconds) to confirm whether there are data therein; if yes, all data in the message transferring queue are sent to the messager pool via the TCP connections; or if the message transferring queue is still empty, it will be re-detected after another fixed time interval. Thus, unnecessary overhead is reduced, and the system performance is optimized.

By applying the system and the method provided by the embodiments of the present disclosure, created live broadcasting messages can be sent to a messager pool in real time to be published only by establishing a fixed number of TCP connections between a message transferring station and the messager pool, instead of establishing a TCP connection between the message pool and each stream creating process and thread. The stream creating processes and threads only need to continually write the created live broadcasting messages into a local Posix message queue, without concerning the TCP connection with the messager pool and a message notification protocol, so that the docking difficulty between the stream creating processes and threads and the messager pool is effectively reduced, the load capacity of an online device is significantly improved, the deployment cost is reduced, and the message publishing capacity is improved.

In the method for optimizing publication of live broadcasting message and the system provided by the embodiments of the present disclosure, by additionally arranging the message transferring station between the messager pool and the stream creating component, the load capacity of an online device and a capacity of the messager pool for publishing messages are effectively improved, and the docking difficulty between the stream creating component and the messager pool is reduced.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. A method for optimizing publication of live broadcasting message, comprising:
configuring a message transferring station between a messager pool for publishing a live broadcasting message and a stream creating component;
creating the live broadcasting message and sending by the stream creating component the live broadcasting message to the message transferring station by the stream creating component; and
sending a received live broadcasting message to the messager pool by the message transferring station.

2. The method of claim 1, wherein said sending by the stream creating component the live broadcasting message to the message transferring station comprises:
writing the created live broadcasting message into a local message queue by the stream creating component; and
reading the live broadcasting message from the message queue, and inserting by the message transferring station the live broadcasting message into a message transferring queue by the message transferring station.

3. The method of claim 2, wherein said writing by the stream creating component the created live broadcasting message into a local message queue comprises: encapsulating the created live broadcasting message, and writing encapsulated data into the message queue based on serial numbers by the stream creating component, the encapsulated data comprising a generating time, a serial number, a type and a published topic location of an m3u8 corresponding to the live broadcasting message; and
said reading the live broadcasting message from the message queue, and inserting by the message transferring station the live broadcasting message into a message transferring queue by the message transferring station comprises: setting a separate thread to read the live broadcasting message from the message queue, and inserting by the message transferring station the live broadcasting message into the message transferring queue based on serial numbers by the message transferring station.

4. The method of claim 2, wherein said sending the received live broadcasting message to the messager pool by the message transferring station comprises:
establishing a fixed number of Transmission Control Protocol (TCP) connections between the message transferring station and the messager pool; and
sending the live broadcasting message to the messager pool in real time via the TCP connections, or re-detecting the message transferring queue at a fixed time interval when it is detected that the message transferring queue is empty, and sending all live broadcasting messages in the message transferring queue to the messager pool via the TCP connections when the message transferring queue is not empty.

5. The method of claim 4, wherein the fixed number of the TCP connection is one.

6. An electronic device for optimizing publication of live broadcasting message comprising: at least one processor; and
a memory communicably connected with the at least one processor for storing instructions executable by the at least one processor, wherein execution of the instructions by the at least one processor causes the at least one processor to:
publish a live broadcasting message and a stream creating component, wherein a message transferring station is configured between a messager pool and the stream creating component;
create a live broadcasting message and send the live broadcasting message to the message transferring station; and
receive the live broadcasting message and send the live broadcasting message to the messager pool.

7. The electronic device of claim 6, wherein the stream creating component comprises a message writing unit configured to write a created live broadcasting message into a local message queue, and
the message transferring station comprises a message reading unit configured to read the live broadcasting message from the message queue and insert the live broadcasting message into a message transferring queue.

8. The electronic device of claim 7, wherein the message writing unit is configured to encapsulate a created live broadcasting message, and write encapsulated data into the message queue based on serial numbers, the encapsulated data comprising a generating time, a serial number, a type and a published topic location of an m3u8 corresponding to the live broadcasting message; and
the message reading unit is configured to set a separate thread to read the live broadcasting message from the message queue, and insert the live broadcasting message into the message transferring queue based on serial numbers.

9. The electronic device of claim 7, wherein the message transferring station further comprises a message sending unit configured to establish a fixed number of Transmission Control Protocol (TCP) connections between the message transferring station and the messager pool, send the live broadcasting message to the messager pool in real time to the messager pool via the TCP connections, or re-detect the message transferring queue at a fixed time interval when it is detected that the message transferring queue is empty, and send all live broadcasting messages in the message transferring queue to the messager pool via the TCP connections when the message transferring queue is not empty.

10. The electronic device of claim 9, wherein the fixed number of the TCP connection is one.

11. A non-transitory computer-readable storage medium storing executable instructions, wherein the executable instructions, when executed by an electronic device comprising a processor, cause the electronic device to:
publish a live broadcasting message;
configure a message transferring station between a messager pool and a stream creating component;
create a live broadcasting message and send the live broadcasting message to the message transferring station; and
receive the live broadcasting message and send the live broadcasting message to the messager pool.

12. The non-transitory computer-readable storage medium according to claim 11, wherein the executable instructions, when executed by the electronic device, further cause the electronic device to:
write a created live broadcasting message into a local message queue, and
read the live broadcasting message from the message queue and insert the live broadcasting message into a message transferring queue.

13. The non-transitory computer-readable storage medium according to claim 12, wherein the executable instructions, when executed by the electronic device, further cause the electronic device to:
encapsulate a created live broadcasting message, and write encapsulated data into the message queue based on serial numbers, the encapsulated data comprising a generating time, a serial number, a type and a published topic location of an m3u8 corresponding to the live broadcasting message; and
set a separate thread to read the live broadcasting message from the message queue, and insert the live broadcasting message into the message transferring queue based on serial numbers.

14. The non-transitory computer-readable storage medium according to claim 12, wherein the executable instructions, when executed by the electronic device, further cause the electronic device to:
establish a fixed number of Transmission Control Protocol (TCP) connections between the message transferring station and the messager pool, send the live broadcasting message to the messager pool in real time to the messager pool via the TCP connections.

15. The non-transitory computer-readable storage medium according to claim 14, wherein the executable instructions, when executed by the electronic device, further cause the electronic device to:
re-detect the message transferring queue at a fixed time interval when it is detected that the message transferring queue is empty, and send all live broadcasting messages in the message transferring queue to the messager pool via the TCP connections when the message transferring queue is not empty.

16. The non-transitory computer-readable storage medium according to claim 12, wherein the executable instructions, when executed by the electronic device, further cause the electronic device to:
establish one Transmission Control Protocol (TCP) connection between the message transferring station and the messager pool, send the live broadcasting message to the messager pool in real time to the messager pool via the TCP connections.
